(19) United States
(12) Patent Application Publication
(10) Pub. No.: US 2009/0212720 A1
(43) Pub. Date: Aug. 27, 2009

(54) LIGHT EMITTING DIODE DRIVING SYSTEM

(75) Inventors: Sheng-Kai Hu, Chu-Nan (TW); Lung-Yu Hung, Chu-Nan (TW); Kai-Chi Lin, Chu-Nan (TW); Chun-Wei Wang, Chu-Nan (TW)

Correspondence Address: PCE INDUSTRY, INC.;ATT. Steven Reiss, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 12/345,879

(22) Filed: Dec. 30, 2008

(30) Foreign Application Priority Data
Feb. 21, 2008 (CN) 200810300365.0

(51) Int. Cl. H05B 41/36

(52) U.S. Cl. 315/307

(57) ABSTRACT

An exemplary light emitting diode driving system includes a protective circuit, a rectifying circuit, a driving circuit, a light emitting diode module and a detecting circuit. The protective circuit, the rectifying circuit, the driving circuit and the light emitting diode module are connected in series. The driving circuit is configured for driving the light emitting diode to emit light. The detecting circuit has predetermined voltages or current values stored therein. The detecting circuit detects the respective voltage or current of the protective circuit, the rectifying circuit and the driving circuit, and compares the respective voltage or current with the predetermined voltages or currents.

### BACKGROUND

1. Technical Field

The present disclosure generally relates to a light emitting diode driving system.

2. Discussion of Related Art

Light emitting diodes (LEDs) have recently been used extensively as light sources for illumination devices due to their high luminous efficiency, low power consumption and long work life. However, the LEDs need to be maintained regularly to avoid abnormal working conditions such as overvoltage/current or physical damage, which, if not remedied, can soon negatively affect performance of the LED.

Therefore, what is needed is a light emitting diode driving system that overcomes the described limitations.

### BRIEF DESCRIPTION OF THE DRAWINGS

Many aspects of the disclosed light emitting diode driving system can be better understood with reference to the following drawings. The components in the drawings are not necessarily drawn to scale, the emphasis instead being placed upon clearly illustrating the principles of the present light emitting diode driving system. Moreover, in the drawings, like reference numerals designate corresponding parts throughout the several views, wherein:

FIG. 1 is a structural view of a light emitting diode driving system, according to a first embodiment; and

FIG. 2 is a structural view of a light emitting diode driving system according to a second embodiment.

### DETAILED DESCRIPTION

Reference will now be made to the drawings to describe the embodiments of the disclosed light emitting diode driving system, in detail.

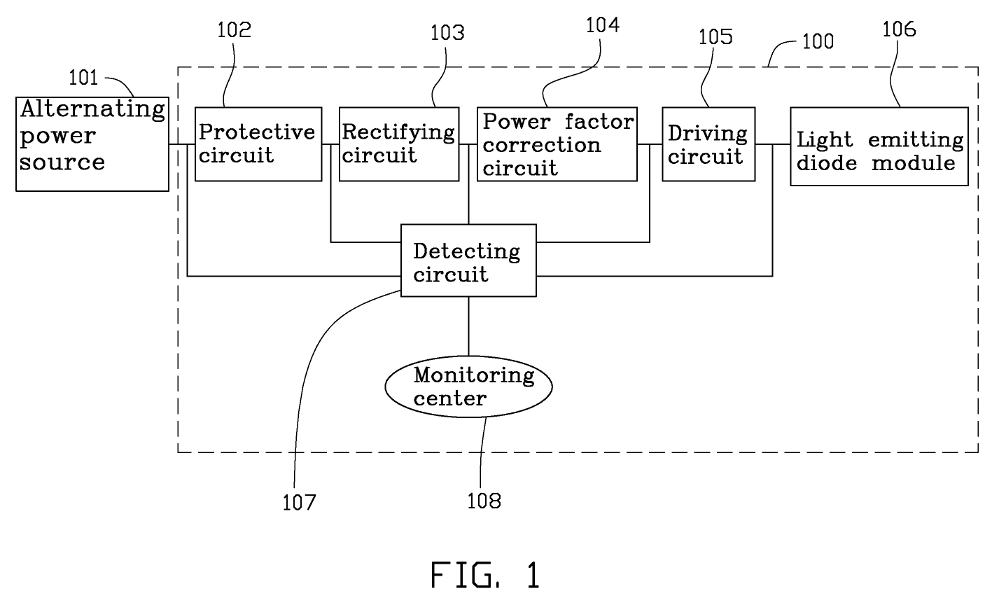

Referring to FIG. 1, a light emitting diode driving system 100, according to a first embodiment, includes a protective circuit 102, a rectifying circuit 103, a power factor correction circuit 104, a driving circuit 105, a light emitting diode module 106, a detecting circuit 107 and a monitoring center 108. The light emitting diode module 106 includes at least one light emitting diode.

An external alternating power source 101 is electrically connected to the protective circuit 112 providing alternating voltage or current to the light emitting diode driving system 100.

The protective circuit 102 includes a voltage protection circuit and a current protection circuit protecting the driving system 100 from excess voltage and current.

The rectifying circuit 103 rectifies voltage or current output by the protective circuit 102. The rectifying circuit 103 can be a bridge rectifier.

The power factor correction circuit 104 decreases phase angles of load voltage and load current, thereby increasing power utilization efficiency of the light emitting driving system 100. In this exemplary embodiment, the power factor correction circuit 104 has a power factor exceeding 0.7.

The driving circuit 105 outputs a constant voltage to drive the light emitting diode module 106 to emit light.

The detecting circuit 107 has predetermined voltage or current values stored therein. The detecting circuit 107 detects the respective voltage or current of the protective circuit 102, the rectifying circuit 103, the power factor correction circuit 104 and the driving circuit 105, and compares the respective voltage or current with the predetermined voltages or current values. When a difference therebetween exceeds an allowable range (generally 15% of the predetermined voltages or current), the detecting circuit 107 sends an alarm signal to the monitoring center 108.

The monitoring center 108 receives the alarm signal sent by the detecting circuit 107, allowing prompt action to be taken to maintain operating integrity of the light emitting diode module 106.

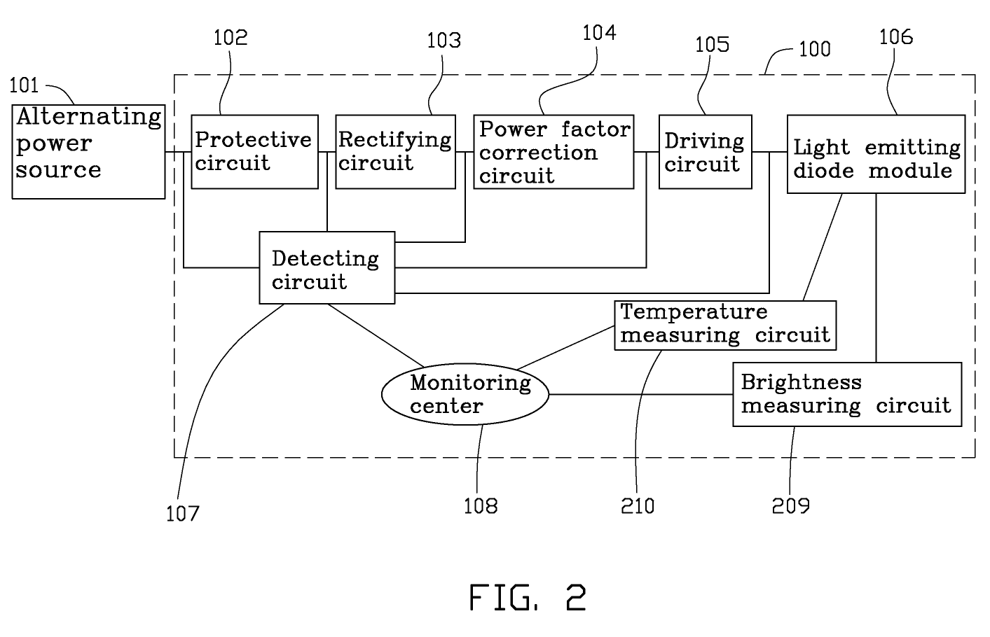

FIG. 2 shows a light emitting diode driving system according to a second embodiment, differing from the previous embodiment only in that light emitting diode driving system further comprises a brightness measuring circuit 209 and a temperature measuring circuit 210.

The brightness measuring circuit 209 has a predetermined brightness value stored therein. The brightness measuring circuit 209 measures the brightness of the light emitting diode module 106 for comparison with the predetermined brightness value. When the difference therebetween exceeds an allowable range (generally 30% of the predetermined brightness value), the brightness measuring circuit 209 sends an alarm signal to the monitoring center 108.

The temperature measuring circuit 210 has a predetermined temperature value stored therein. The temperature measuring circuit 210 measures the working temperature of the light emitting diode module 106 for comparison with the predetermined temperature value. When the working temperature measured by the temperature measuring circuit 210 exceeds the predetermined temperature value, the temperature measuring circuit 210 sends an alarm signal to the monitoring center 108.

Finally, it is to be understood that the above-described embodiments are intended to illustrate rather than limit the disclosure. Variations may be made to the embodiments without departing from the spirit of the disclosure as claimed. The above-described embodiment illustrates the scope of the disclosure but do not restrict the scope of the disclosure.

What is claimed is:

1. A light emitting diode driving system, comprising:
a protective circuit,
a rectifying circuit,
a driving circuit,
a light emitting diode module and
a detecting circuit, wherein the protective circuit, the rectifying circuit, the driving circuit, and the light emitting diode module are connected in series; the driving circuit configured for storing predetermined voltage or current values therein and driving the light emitting diode to emit light; the detecting circuit configured for detecting the respective voltage or current of the protective circuit, the rectifying circuit and the driving circuit, and comparing the measured voltage or current with the predetermined voltages or currents.

2. The light emitting diode driving system according to claim 1, wherein the light emitting diode module comprises at least one light emitting diode.

3. The light emitting diode driving system according to claim 1, further comprising a power factor correction circuit electrically coupled between the rectifying circuit and the driving circuit.

4. The light emitting diode driving system according to claim 3, wherein the power factor correction circuit has a power factor exceeding 0.7.

5. The light emitting diode driving system according to claim 1, further comprising a monitoring center connected to the detecting circuit to which the detecting circuit sends an alarm signal when the difference between the detected voltage or current and the predetermined voltage or current value exceeds an allowable range.

6. The light emitting diode driving system according to claim 5, further comprising a brightness measuring circuit having a predetermined brightness value stored therein and measuring the brightness of the light emitting diode module, the brightness measuring circuit configured for sending an alarm signal to the monitoring center when a difference between the measured brightness and the predetermined brightness value exceeds an allowable range.

7. The light emitting diode driving system according to claim 5, further comprising a temperature measuring circuit having a predetermined temperature value stored therein and measuring the working temperature of the light emitting diode, the temperature measuring circuit configured for sending an alarm signal to the monitoring center when the working temperature exceeds the predetermined temperature value.

8. The light emitting diode driving system according to claim 1, wherein the rectifying circuit is a bridge rectifier.

9. The light emitting diode driving system according to claim 1, wherein the driving circuit is configured for outputting a constant voltage.
